(19) United States
(12) Patent Application Publication
(10) Pub. No.: US 2006/0112274 A1
(43) Pub. Date: May 25, 2006

(54) Method for accessing wireless Internet content in a mobile communication terminal

(75) Inventor: Ki-Tae Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/177,029

(22) Filed: Jul. 8, 2005

(30) Foreign Application Priority Data
Nov. 25, 2004 (KR) 10-2004-0097676

(51) Int. Cl. H04L 9/00

(52) U.S. Cl. 713/171

(57) ABSTRACT

A method is provided for accessing wireless Internet content in a mobile communication terminal. An Internet shortcut key for which a string of keycodes for accessing specific content on a wireless Internet is assigned is registered. When the Internet shortcut key is input, the keycode string assigned for the Internet shortcut key is read and the Internet content is accessed.

### PRIORITY

This application claims priority to an application entitled “METHOD FOR ACCESSING WIRELESS INTERNET CONTENT IN A MOBILE COMMUNICATION TERMINAL”, filed in the Korean Intellectual Property Office on Nov. 25, 2004 and assigned Serial No. 2004-97676, the contents of which are incorporated herein by reference.

### BACKGROUND OF THE INVENTION

1. Field of the Invention

The present invention relates generally to a method for accessing desired wireless Internet content by a single manipulation of an Internet shortcut key in a mobile communication terminal, and more particularly to a method for easily accessing desired wireless Internet content by a single manipulation of an Internet shortcut key when a series of keys are assigned and registered in advance for the Internet shortcut key.

2. Description of the Related Art

With the development of supplementary functions, mobile communication terminals can now perform not only voice communication functions, but also data communication functions through General Packet Radio Service (GPRS), Code Division Multiple Access (CDMA) Evolution-Data Optimized (EV-DO), CDMA Evolution-Data Voice (EV-DV), Wideband Code Division Multiple Access (WCDMA) High Speed Downlink Packet Access (HSDPA), etc. communication techniques and/or systems. As compared with a general personal computer (PC), the mobile communication terminal has a small display screen and a small keypad. As special functions associated with a wireless Internet platforms, wireless Internet web browsers, hot keys, browser connection keys, etc. have been added to mobile communication terminals, the mobile communication terminal has become simpler and more convenient to use. More specifically, when a menu shortcut key registered for a general menu provided in the mobile communication terminal itself is input only once, a desired menu can be immediately displayed.

FIG. 1 is a flow chart illustrating a process for operating a menu shortcut key. In order for the menu shortcut key to be operated, a specific function key on the keypad must be registered as the menu shortcut key (at step 102). In the menu shortcut key registration (at step 102), a string of keycodes is assigned for the menu shortcut key such that a registered menu can be immediately displayed when the specific function key is pressed. For example, to view a received message list of a message box, the user must sequentially press an SMS message item (mapped to a “Message” key of the keypad), a received message item (mapped to a “1” key of the keypad), and a text box item (mapped to a “2” key of the keypad). When a specific function key such as a “*” or “#” key is assigned and registered as a shortcut key to display a received message list, the “Message”, “1”, and “2” keys are stored and registered in a first-in first-out (FIFO) buffer in order of input. Hereinafter, a value of a key stored in the FIFO buffer is referred to as the “keycode”.

When the user presses a corresponding specific function key after the menu shortcut key registration (at step 102), the mobile communication terminal enters menu shortcut key operating mode (at step 104) and first initializes read-indexing to sequentially read keycodes registered in the FIFO buffer (at step 106). According to the read-indexing initialization, an address first stored in the FIFO buffer is indicated. After initializing the read-indexing (at step 106), a keycode at a corresponding read-indexing address is read (at step 108). A virtual key is generated from the read keycode. When the generated virtual key is sent to a key input unit for processing a key input (at step 110), the key input unit determines that the virtual key is externally input and performs an operation assigned to the key. After generating and sending the virtual key (at step 1 10), it is determined if a corresponding keycode is the last keycode, that is, if the next keycode assigned for a corresponding menu shortcut key is stored in the FIFO buffer (at step 112). If a corresponding keycode is the last keycode as indicated by reference numeral 112a, the process for operating the menu shortcut key is completed. If a corresponding keycode is not the last keycode as indicated by reference numeral 112b, a read-indexing value is incremented by one (at step 114). The next keycode is read from the FIFO buffer (at step 108). A virtual key message associated with the next keycode is generated and sent (at step 110). The above-mentioned process is repeated until the last keycode has been read. Consequently, the user can conveniently and easily access a specific menu provided by the mobile communication terminal through such a menu shortcut key operation.

However, there is a problem in that the shortcut key cannot be conventionally provided to access an Internet menu downloaded through wireless Internet access. That is, a special Internet shortcut key cannot be provided, because the Internet menu access depends upon only an Internet server regardless of the mobile communication terminal after it accesses the Internet wirelessly. Further, because a new menu can be selected after a web page for providing an Internet menu to be selected has been completely downloaded in view of characteristics of the Internet, the Internet shortcut key capable of directly accessing a desired menu cannot be provided. The users are thus inconvenienced in that they can only obtain Internet information after several key inputs, a reply standby time, and perhaps as many as several display changes may be required to view financial or traffic information. Moreover, the users may be inconvenienced because they must view a small screen and enter keys to access the Internet menu.

### SUMMARY OF THE INVENTION

Accordingly, the present invention has been designed to solve the above and other problems occurring in the prior art. Therefore, it is an aspect of the present invention to provide an Internet shortcut key serving as a menu shortcut key at an Internet access time in a mobile communication terminal. Moreover, it is another aspect of the present invention to provide an algorithm for easily accessing desired Internet content by operating an Internet shortcut key. It is yet a further aspect of the present invention to provide a method for operating an Internet shortcut key through voice recognition as well as a keypad input.

The above and other aspects of the present invention can be achieved by a method for accessing wireless Internet content in a mobile communication terminal. The method includes registering an Internet shortcut key for which a string of keycodes for accessing specific content on a wireless Internet is assigned; and when the Internet shortcut key is input, reading the keycode string assigned for the Internet shortcut key and accessing the Internet content.

Preferably, accessing the Internet content may include reading a first keycode first input in the keycode string assigned to register the Internet shortcut key; determining that a key corresponding to the first keycode is input from a keypad and accessing first Internet content; reading a second keycode serving as a next keycode and accessing second Internet content when the second keycode is present after the first Internet content is completely accessed, and maintaining the first Internet content access when the next keycode is absent; and repeating the reading and accessing until a last keycode is read after the second Internet content access is completed, and sequentially performing Internet content accesses to access last Internet content.

### BRIEF DESCRIPTION OF THE DRAWINGS

The above and other aspects and advantages of the present invention will be more clearly understood from the following detailed description taken in conjunction with the accompanying drawings, in which:

FIG. 1 is a flow chart illustrating a conventional process for operating a menu shortcut key;

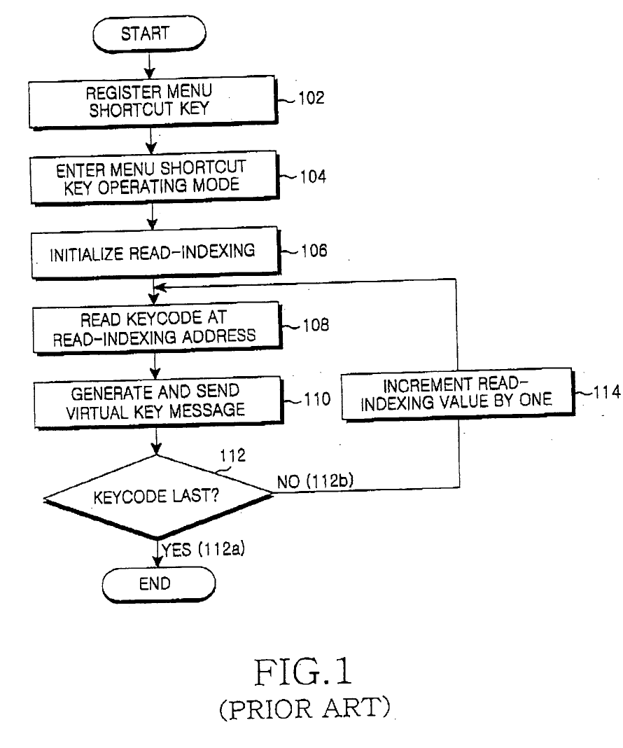

FIG. 2 is a block diagram illustrating the internal configuration of a mobile communication terminal according to an embodiment of the present invention;

FIG. 3 is a flow chart illustrating a process for registering an Internet shortcut key according to an embodiment of the present invention;

FIG. 4 is a flow chart illustrating a process for accessing specific wireless Internet content using the Internet shortcut key according to an embodiment of the present invention; and

FIG. 5 is a block diagram illustrating an example of operating the Internet shortcut key according to an embodiment of the present invention.

### DETAILED DESCRIPTION OF THE PREFERRED EMBODIMENTS

Preferred embodiments of the present invention will be described in detail herein below with reference to the accompanying drawings. In the drawings, the same or similar elements are denoted by the same reference numerals even though they are depicted in different drawings. In the following description, a detailed description of known functions and configurations incorporated herein will be omitted for conciseness.

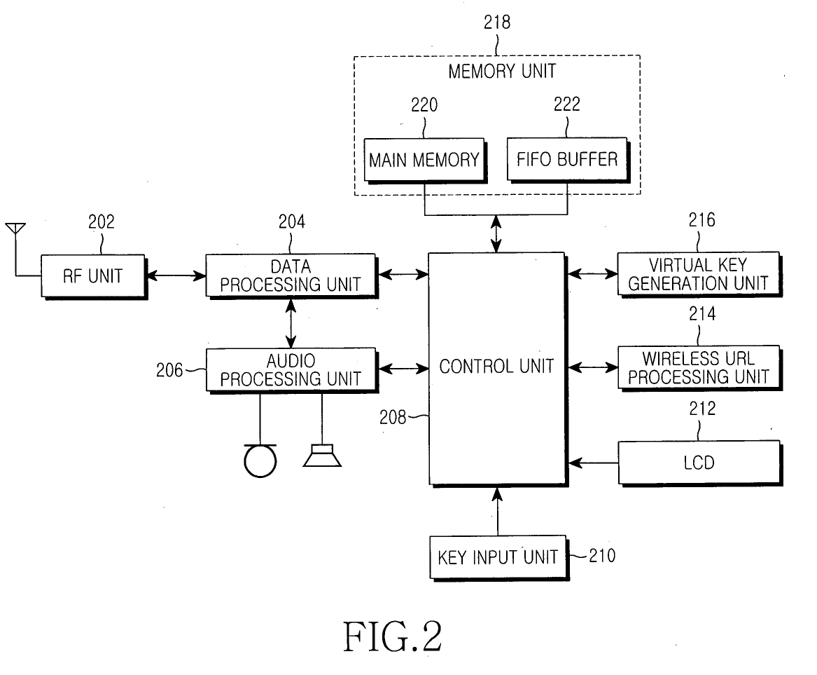

FIG. 2 is a block diagram illustrating a mobile communication terminal according to an embodiment of the present invention. A radio frequency (RF) unit 202 performs a wireless communication function of the mobile communication terminal. The RF unit 202 includes an RF transmitter (not shown) for up converting and amplifying a frequency of a signal to be transmitted, and an RF receiver (not shown) for low-noise amplifying a received signal and down converting a frequency of the received signal. A data processing unit 204 includes a transmitter (not shown) for coding and modulating the signal to be transmitted and a receiver (not shown) for demodulating and decoding the received signal. That is, the data processing unit 204 can include a modulator-demodulator (MODEM, not shown) and a coder-decoder (CODEC, not shown). The CODEC includes a data CODEC for processing packet data, etc. and an audio CODEC for processing an audio signal such as voice, etc.

An audio processing unit 206 performs a function for reproducing a received audio signal output from the data processing unit 204 through a speaker or outputting a transmission audio signal generated from a microphone to the data processing unit 204.

A key input unit 210 includes keys necessary for inputting number and letter information and function keys necessary for setting and selecting various functions. A liquid crystal display (LCD) 212 displays an image signal output from a control unit 208. The control unit 208 performs a function for controlling respective components to control the overall operation of the mobile communication terminal. More specifically, the control unit 208 reads a keycode stored in a first-in first-out (FIFO) buffer 222 and sends the read keycode to a virtual key generation unit 216. The control unit 208 controls the respective components such that an Internet shortcut key can be easily selected by a user.

A memory unit 218 includes a main memory 220 and the FIFO buffer 222 in accordance with the present invention. A booting program and an operating system (OS) are resident in a main memory 220. The main memory 220 stores an operation algorithm program to control the overall operation of the mobile communication terminal. More specifically, the FIFO buffer 222 uses a nonvolatile memory such as a flash memory in accordance with the present invention. The FIFO buffer 222 serves as a memory for storing data according to a FIFO technique and is a buffer from which data is output in the order in which the data was stored. Accordingly, keycodes associated with the Internet shortcut key are stored in the FIFO buffer 222 in the order in which they are input.

The virtual key generation unit 216 reads a keycode stored in the FIFO buffer 222 and generates a virtual key from the read keycode. That is, the virtual key generation unit 216 generates the virtual key with the same function as a function of a key input by a user through a keypad. The generated virtual key is sent to a wireless uniform resource locator (URL) processing unit 214. The wireless URL processing unit 214 operates in response to the received generated virtual key.

The wireless URL processing unit 214 performs a function for providing Internet protocol (IP) and physical hardware such that the mobile communication terminal can use an Internet service through a wireless network. The wireless URL processing unit 214 performs a function for packetizing and decoding data according to a wireless Internet related protocol to exchange wireless Internet data through the RF unit 202. More specifically, when wireless Internet access is performed, the wireless URL processing unit 214 determines if the wireless Internet access has been successfully completed, and displays a result of the determination on the mobile communication terminal. Then, the wireless URL processing unit 214 receives the next wireless Internet access command from the user. In relation to the Internet shortcut key in accordance with the present invention, the wireless URL processing unit 214 completes specific Internet content access requested and then notifies the virtual key generation unit 216 that the requested specific Internet content access has been completed. Then, the wireless URL processing unit 214 receives the next virtual key.

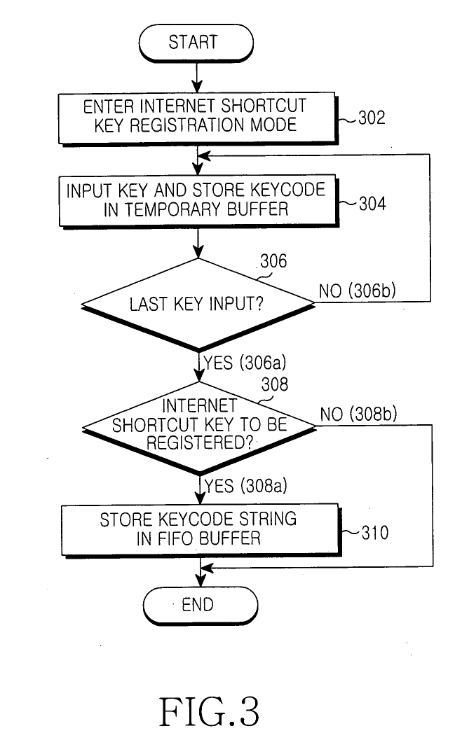

FIG. 3 is a flow chart illustrating a process for registering an Internet shortcut key to operate the registered Internet shortcut key in accordance with an embodiment of the present invention. When the mobile communication terminal enters an Internet shortcut key registration mode to register the Internet shortcut key (step 302), the control unit 208 performs a task for receiving an Internet shortcut key and a string of keycodes to be assigned for the Internet shortcut key from the user.

The control unit 208 receives a first key input corresponding to a first keycode in the keycode string to be registered for the Internet shortcut key and stores the first keycode in a temporary buffer (step 304). The control unit 208 determines if a current key input is the last key input (step 306). At step 306, if the current key input is not the last key input as indicated by reference numeral 306b, the control unit 208 receives the next key corresponding to the next keycode from the user and sequentially stores the next keycode in the temporary buffer (step 304). Alternatively, in step 306, if the current key input is the last key input, where the last key input can be determined when a special storing completion key is input from the user, the controller continues to step 308. Referring back to step 306, the last key input determination may be performed according to various methods. However, when a key is no longer input or when the user inputs the storing completion key as indicated by reference numeral 306a, the control unit 208 continues to step 308 and asks if the user desires to register the keycode string stored in the temporary buffer as the keycode string for the Internet shortcut. At step 308, when the user desires to register the keycode string for the Internet shortcut key as indicated by reference numeral 308a, the keycode string for the Internet shortcut key is stored and registered in the FIFO buffer 222. However, when the user does not desire to register the keycode string as indicated by reference numeral 308b, the keycode string is not registered in the FIFO buffer 222 and the Internet shortcut key registration mode is terminated.

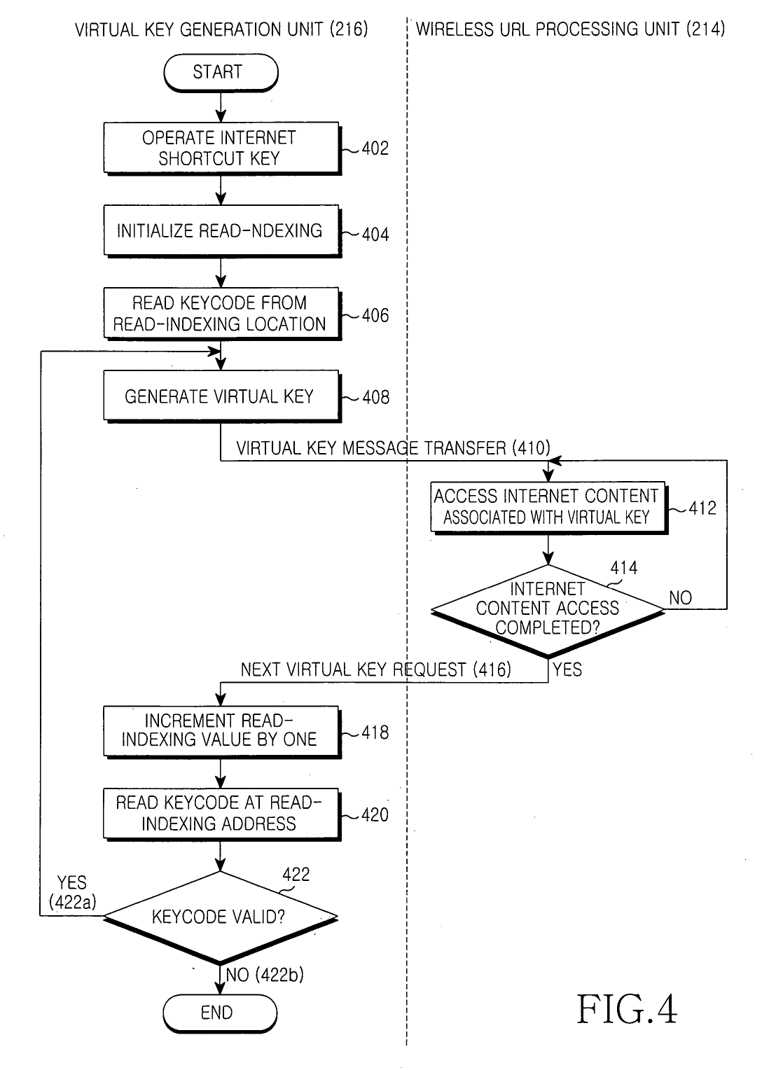

FIG. 4 is a flow chart illustrating a process for accessing specific wireless Internet content by operating the Internet shortcut key in accordance with an embodiment of the present invention. When the Internet shortcut key is pressed and operated by the user (step 402), the virtual key generation unit 216 initializes read-indexing (step 404). The read-indexing initialization is performed to set a first reading address in the FIFO buffer 222. Because the FIFO buffer 222 stores data according to the FIFO format in the present invention, read-indexing is set at an address for storing a first input keycode when the Internet shortcut key is registered. After initializing the read-indexing (step 404), a keycode is read from a corresponding read-indexing location (step 406). The virtual key generation unit 216 generates a virtual key corresponding to the read keycode (step 408) and then sends the generated virtual key to the wireless URL processing unit 214 (step 410). The virtual key has the same function as a key input through the keypad. The wireless URL processing unit 214 determines that a specific key has been input through a virtual keypad by receiving the virtual key generated by the virtual key generation unit 216. The wireless URL processing unit 214 attempts wireless Internet access to a corresponding Internet content in response to a specific content Internet access command or a request assigned to the received virtual key (step 412). The wireless URL processing unit 214 determines if the requested Internet content access has been completed (step 414). The access is continuously attempted until completed, and the virtual key generation unit 216 stays in an idle state.

In more detail, when the Internet shortcut key is operated, an Internet start menu access keycode stored first in the FIFO buffer 222 is read such that Internet start menu access can be performed (step 406). The virtual key generation unit 216 identifies the read Internet start menu access keycode and generates a virtual key for Internet start menu access serving as an Internet start menu key input through the keypad (step 408). The virtual key generation unit 216 sends the generated virtual key to the wireless URL processing unit 214 (step 410). The wireless URL processing unit 214 receives the virtual key for the Internet start menu access, and downloads and accesses Internet start menu content through the wireless Internet such that an Internet start menu is displayed on a window of the mobile communication terminal (steps 412 and 414).

When the requested Internet content has been completely accessed, the wireless URL processing unit 214 requests that the virtual key generation unit 216 provide the next virtual key associated with the next phase for Internet access (step 416). When receiving the virtual key request, the virtual key generation unit 216 increments a read-indexing value by one to read the next keycode (step 418). Subsequently, a keycode is read at a corresponding read-indexing address (step 420). When it is determined that the read keycode is invalid as a null code (as indicated by reference numeral 422b), a task associated with the Internet shortcut key is terminated and a current Internet access state is maintained. However, when the keycode read at the read-indexing address is valid (as indicated by reference numeral 422a), a virtual key corresponding to the read keycode is generated (step 408), and the generated virtual key is sent to the wireless URL processing unit 214 (step 410). The wireless URL processing unit 214 accesses corresponding Internet content according to the received virtual key (steps 412 and 414).

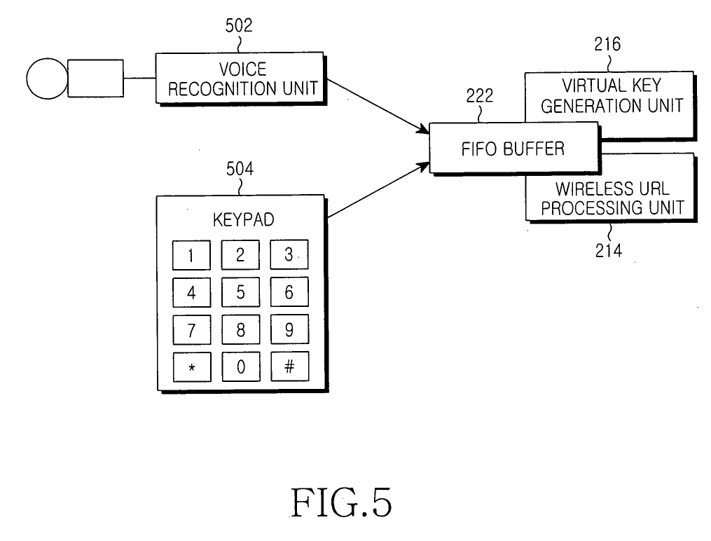

Referring to FIG. 5, the Internet shortcut key is operated in step 402 when a specific Internet shortcut key on a keypad 504 is pressed. Alternatively, when a voice recognition unit 502 may be provided for a convenient key input, the Internet shortcut key may be operated through a voice recognition function. For example, a voice signal “weather forecast” serving as the Internet shortcut key and a series of keycode numbers for the “weather forecast” shortcut key are assigned and registered. In this case, when the user says the phrase “weather forecast” to the mobile communication terminal, virtual keys are generated from a string of keycodes assigned for the Internet shortcut key corresponding to the voice signal “weather forecast”, and wireless Internet content of “weather forecast” can be accessed through the process of FIG. 4.

Although preferred embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

What is claimed is:

1. A method for accessing wireless Internet content in a mobile communication terminal, comprising:
registering an Internet shortcut key for which a string of keycodes for accessing specific content on a wireless Internet is assigned; and
reading the keycode string assigned for the Internet shortcut key and accessing the Internet content, when the Internet shortcut key is input.

2. The method according to claim 1, wherein the step of registering the Internet shortcut key for which the keycode string is assigned comprises:
storing the keycodes in a first-in first-out (FIFO) buffer such that the keycodes are output according to a FIFO technique.

3. The method according to claim 1, wherein the keycodes are stored in a first-in first-out (FIFO) buffer after the keycodes to be registered are temporarily stored and a last keycode is input.

4. The method according to claim 1, wherein the Internet shortcut key is input when a specific key on a keypad is pressed.

5. The method according to claim 1, wherein the Internet shortcut key is input when a voice command from a user is received and recognized.

6. The method according to claim 1, wherein the step of accessing the Internet content when the Internet shortcut key is input further comprises:
reading a first keycode input in the keycode string assigned to register the Internet shortcut key;
determining that a key corresponding to the first keycode is input from a keypad and accessing first Internet content;
reading a second keycode serving as a next keycode and accessing second Internet content when the second keycode is present after the first Internet content is completely accessed, and maintaining the first Internet content access when the next keycode is absent; and
repeating the reading and accessing steps until a last keycode is read after the second Internet content access is completed, and sequentially performing Internet content accesses to access last Internet content.

7. The method according to claim 6, wherein the step of determining that the key is input from the keypad and accessing the Internet content comprises:
generating a virtual key serving as a value of the key, input from the keypad, corresponding to the read keycode; and
determining that the key is input from the keypad and accessing the Internet content according to the generated virtual key.
